(19) United States
(12) Patent Application Publication
(10) Pub. No.: US 2006/0036503 A1
(43) Pub. Date: Feb. 16, 2006

(54) Method for selecting and purchasing a gift

(76) Inventors: Rene Schweier, Stuttgart (DE); Gerd Schweier, Stuttgart (DE)

Correspondence Address: DREISS, FUHLENDORF, STEIMLE & BECKER, POSTFACH 10 37 62, D-70032 STUTTGART, DE

(21) Appl. No.: 10/916,387

(22) Filed: Aug. 12, 2004

(51) Int. Cl. G06Q 30/00

(52) U.S. Cl. 705/26

(57) ABSTRACT

A method and a client-server system for selecting and purchasing a gift that will be donated to a receiving user. A donating user causes a client system to send information identifying the receiving user to a server system. The server system sends information to the client system identifying at least one gift from a gift list, wherein the gift list is assigned to the receiving user and wherein the gift is offered for sale by an online-shop that is assigned to the server system. The client system receives the information identifying the gift and causes a description of the gift to be displayed to the donating user. The donating user selects the gift and causes a request to purchase the selected gift to be sent to the online shop. The server system removes the gift from the gift list, if the donating user purchases the gift.

### BACKGROUND OF THE IVENTION

The present invention relates to a method and to a system for the selection and the purchase of a gift.

A gift can be any item, i.e. any product and any service that can be purchased by a donating person and donated to a receiving person. Typically, a donor intending to donate a gift to a recipient first asks the recipient to give a suggestion about what kind of gift the recipient wishes. Frequently, the recipient gives a gift list to the donor. The donor selects a gift from the gift list and purchases the gift at a shop that offers the gift for sale.

Purchasing an item at an online-shop is becoming the preferred means for obtaining consumer products and services. An online-shop basically is a computer system that is connected to a computer network, e.g. the Internet. A client system or client assigned to a user is also connected to the computer network. The client is for example a personal computer that is connected to the Internet. For purchasing an item, e.g. a gift, a purchase order is sent from the client to the online-shop via the computer network. A computer software, e.g. a browser, is installed on the client computer. The browser enables the client computer to send information to the online-shop and to display information received from the online-shop to the client. The information that is sent from the online-shop to the client is frequently coded in HTML (Hypertext Markup Language) and transmitted as a so-called Web page.

Typically, online-shops provide product information, including product descriptions, pricing, and availability. To retrieve this information from the online-shop, the user first calls the online-shop by typing a unique address into the browser wherein the unique address is assigned to the shop. Within the Internet the unique address is called an URL (Uniform Resource Locator). The user can also call the online-shop by activating a so-called link to the online-shop's Web page, the link being displayed on another Web page.

In return, the online-shop sends a Web page e.g. the so-called home page, to the client. The client receives this Web page and displays it to the user. The Web page typically contains links to further Web pages, e.g. to Web pages that provide product information. Each link is assigned to an URL and since each URL is assigned to a Web page, activating the link by the user causes the online-shop to send the appropriate Web page to the user.

To find an online-shop that offers an ascertained item (e.g. a gift) the user (e.g. the donor) often uses specialized servers, e.g. search engines. To find a shop that offers the selected gift for sale, the donor calls the search engine using the client and sends a keyword to the search engine via the Internet, wherein the key word describes the name of a product. The search engine in return sends a list of links to online-shops that offer the gift for sale.

Although online-shops offer a great convenience in purchasing a selected gift, the donor still has to ask the recipient to give him the gift list, locate an online-shop that offers the selected gift for sale, and submit a purchase order. This usually is a time consuming and inconvenient task. Moreover, if two or more donors receive the same list from the recipient, it is possible that both donors purchase the same gift.

### SUMMARY OF THE INVENTION

It is an object of the present invention to provide an improved system for selecting and purchasing a gift that is more convenient and allows to reduce the likelihood that two or more donors purchases the same gift for one recipient.

This object is solved by the method of the independent method claim. The object is also solved by the server system of the independent device claim.

According to the present invention, the donating user requests information identifying at least one gift from a gift list that is maintained by a server system. The gift list comprises information for identifying one or more gifts the receiving user would like to receive. Each gift within the gift list can be purchased by at least one online-shop that is assigned to the server system.

In an embodiment of the invention, the information that identifies the gift is a link to a Web page hosted by an online-shop. If the donating user activates this link, the online-shop causes the Web page to be transmitted to the client system of the donating user. The Web for instance provides a description of the gift and allows the donating user to order the gift, e.g. by providing a button on the Web page that can be activated by the donating user.

If the donating user purchases the gift, the gift is automatically removed from the gift list. To detect that the gift is purchased by the donating user, it is conceivable that the user sends an appropriate message, e.g. by e-mail, to the server system. Preferably, the server system allows the donating user to activate a button on a Web page that is displayed to the donating user. If the donating user activates this button the client system sends information to the server system indicating the purchase of the gift.

Further embodiments of the invention are provided in the dependent claims. In particular, it is emphasized that a computer program or a computer program product, which are able to execute the method of the independent method claim when run on a data processing system, may also realize the invention.

### BRIEF DESCRIPTION OF THE DRAWING

FIG. 1 is a schematic block diagram of a client-server system in a first embodiment;

FIG. 2 is a schematic block diagram of features of the server of a client-server system of FIG. 1 in more detail;

FIG. 3 is a schematic block diagram of features of a server of a client-server system in a second embodiment in more detail;

FIG. 4 is a flow diagram of an embodiment of the present invention; and

FIG. 5 is an embodiment of a Web page for adding and modifying information that is to be stored on a server of the client-server system.

### DESCRIPTION OF THE PREFERRED EMBODIMENT

The invention together with further objects, advantages, features and aspects thereof will be more clearly understood from the following description taken in connection with the accompanying drawings.

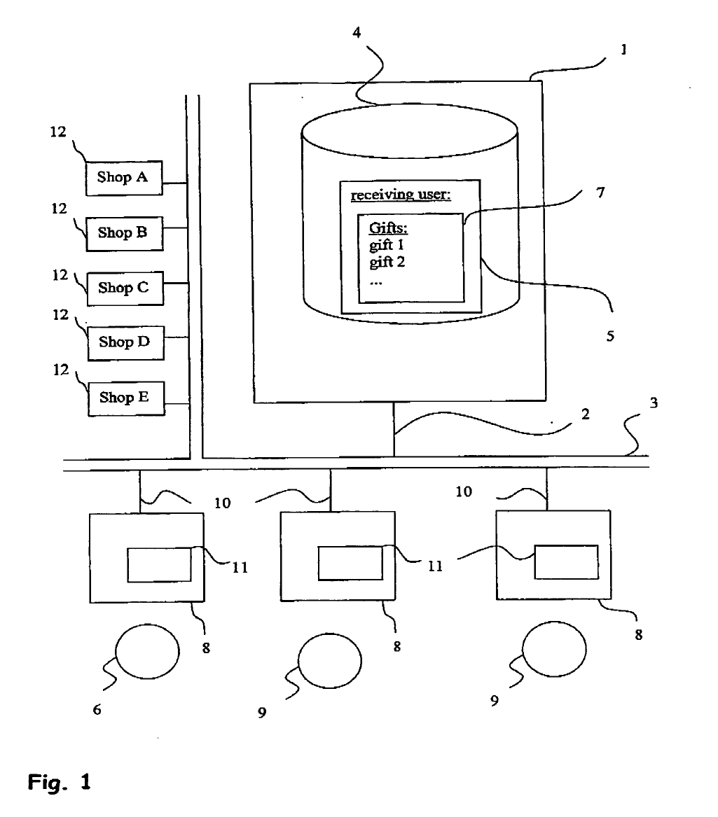

FIG. 1 shows an embodiment of a client-server system for selecting and purchasing a gift for a recipient. The client-server system comprises a server system e.g. a server 1 that is connected via a data line 2 with a computer network, e.g. the Internet 3. The server 1 comprises a database 4 that holds a data entry 5 for a receiving user 6. The data entry comprises a gift list 7 that is assigned to the receiving user 6. The gift list 7 comprises one or more gifts the recipient 6 would like to receive. Various realizations of the database 4 are conceivable as known to one skilled in the art. For example, the database 4 can be implemented on another server wherein the server 1 communicates with the other server and thus with the database 4 via a computer network, e.g. the Internet 3. It is also conceivable, that the database 4 is distributed on several other servers that communicate via one or more computer networks.

FIG. 1 also shows clients 8. At least one client 8 is assigned to each donating user 9 and to the receiving user 6. Each client 8 is connected to the Internet 3 via a data line 10. In this embodiment a browser 11 is installed on each of the clients 8 enabling the client 8 to communicate with the server 1. One or more clients 8 can be realized as personal computers, e.g. as laptops. It is also conceivable to realize one or more clients 8 as mobile phones or as hand-held computers. The data lines 10 can also be realized and/or supplemented for example by a mobile telecommunication network.

The client-server system also comprises one or more shops 12 that are connected to the Internet 3. The shops 12 are so called online-shops that offer items for sale via the Internet 3. It has to be emphasized that the shops 12 can also comprise online-shops, that work in the field of B2B (Business to Business), which means that they do not sell any item to a consumer. This allows the server 1 itself to act as an online-shop (B2C; Business to Consumer) in selling a selected gift to a donating user 9, wherein the server 1 first purchases this gift itself at a shop 12. It is conceivable that one or more of the shops 12 are realized as an online-auction system, e.g. www.ebay.com.

The shops 12 comprise a database that holds, at least for each item that is offered for sale by the shop 12, information that is related to the item. This information can comprise text-based information such as a description, price, and availability of the item. The information can also comprise graphics for visualizing the item.

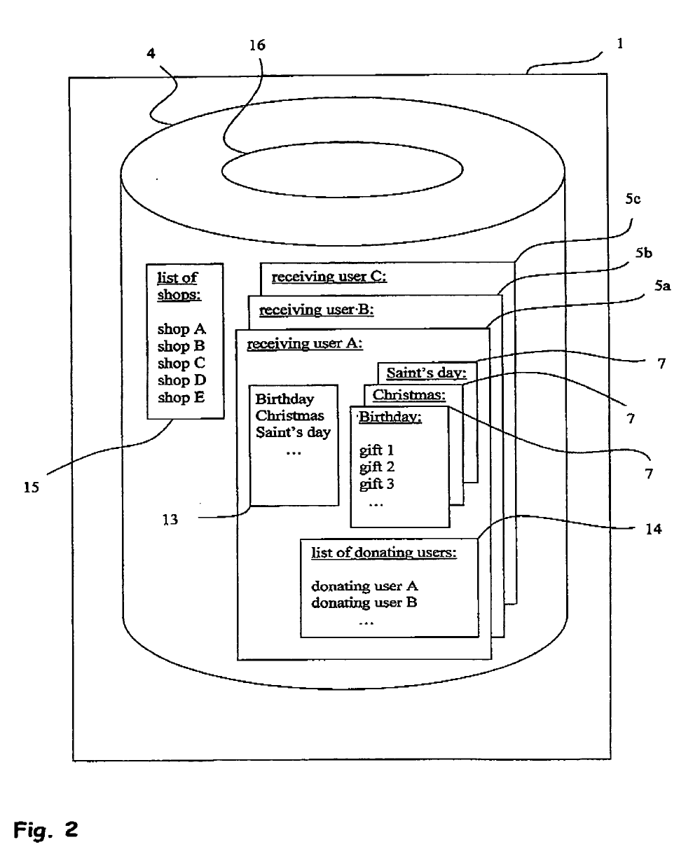

FIG. 2 illustrates an embodiment of the server 1 and in particular the data base 4 in more detail. The database 4 maintains an entry 5a, 5b, 5c for one or more receiving users 6. Each entry 5a, 5b, 5c provides an event list 13 and one or more gift lists 7. Each gift list 7 is assigned to at least one event from the event list 13. As illustrated in FIG. 2, the event list 13 of entry 5a contains an entry for the birthday of the receiving user 6, Christmas, and the Saint's day of the receiving user 6. The database 4 can provide an appropriate event list 13 for further receiving users 6. For at least one event out of the event list 13, the database 4 holds a gift list 7. The gift list 7 contains information that permits identification of at least one gift the receiving user 6 would like to receive from the donating user 9 in accordance with the event.

In addition, the data base 4 provides, for each receiving user 6, a list 14 of donating users 9 which contains information that permits identification of one or more donating users 9 that should be allowed to view one or more gift lists 7 and/or the event list 13 of the appropriate receiving user 6.

The database 4 also provides a shop list 15 that contains information identifying each shop 12 that is assigned to the server 1. Preferably, each of the shops from the shop list 15 offers for sale at least one gift out of a gift list 7 from a receiving user 6. At least, the shops from the shop list 15 are likely to offer a gift for sale, that might be wished by a receiving user 5a, 5b, 5c.

The server 1 further comprises a search engine 16 that is connected to the database 4. The search engine allows the donating user 9 to search the information within the database 4 for a gift list 7 of the receiving user 6, wherein the receiving user 6 can be identified by a keyword. In another embodiment, the search engine 16 also permits a search for one or more events out of the event list 13 of an identified receiving user 6.

The structure of the data base 4 as shown in FIG. 2 and also the functionality of the search engine 16 is just one example to illustrate the invention by describing one embodiment of the invention. The embodiments shown here illustrate the connection of different kinds of information. One skilled in the art can realize the database 4 and the search engine 16 in various different ways. It is for example conceivable that the event list 13 and the gift lists 7 are realized as nested lists, e.g. such that the event list 13 comprises a gift list 7 for each event.

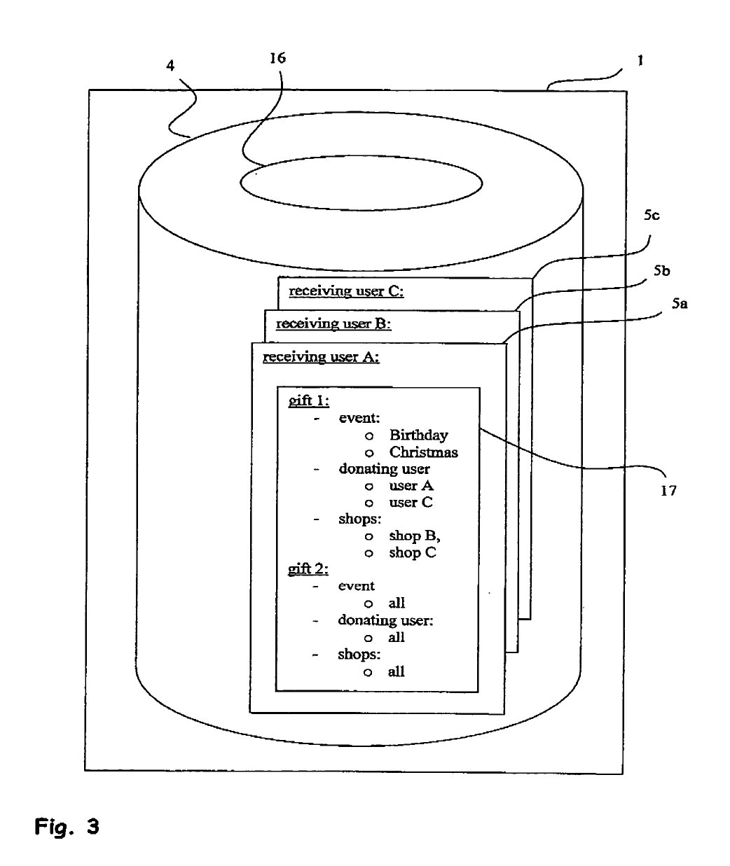

FIG. 3 shows an embodiment of the invention where the database 4 contains just one gift list 17 for each receiving user. The gift list 17 contains information that identifies a gift. Each gift within the gift list 17 is added by information that identifies at least one event. This event e.g. comprises information about when the receiving user 6 wants to receive the gift. Each gift within the gift list 17 is further added by information that identifies one or more donating users 9 that are allowed to retrieve the information identifying the gift.

The gift list 17, as shown exemplary in FIG. 3, specifies that the receiving user 5a would like gift 1 to be given either on a Birthday or on Christmas from user A or from user C. Gift list 17 also specifies, that gift 1 can be purchased in shop B and shop C. Gift 2 can be given at any event from any donating user 9 and could be purchased at any shop.

Preferably, the information defining one or more shops 12 is represented or at least added by a link to the shop 12 or directly to a Web page that is hosted by the shop 12 and contains information according to the gift 1.

The search engine 16 can thus be realized to allow various requests. For example, a donating user 9 can request information about which gifts from a specific shop 12 can be purchased for donating to one specific receiving user 6. It is also conceivable, that a donating user 9 defines a specific gift and requests information about which receiving user 6 wants this gift to be given at which event. These data can be connected in various ways and thus provide the possibility of requesting a multitude of different information out of the database 4. One or more commercial or open source data base products can realize the database 4. The search engine 16 can also be realized using a search engine component available on the software market.

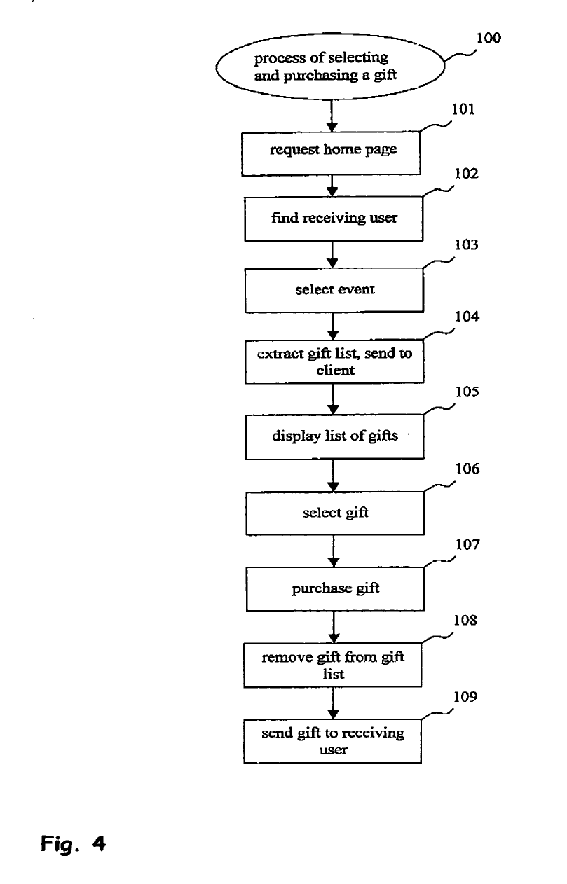

FIG. 4 shows a flow diagram of an embodiment of the process 100 of selecting and purchasing a gift according to the present invention. In a step 101 the donating user 9 requests information from the server 1. Therefore, the donating user 9 first uses the client 8 to request the display of a Web page stored on the server 1 by issuing a request via the Internet 3 to the server 1. An URL that is assigned to the home page of the server 1 can realize the request. The server 1 responds to the request by sending the home page to the client 8 of the donating user 9.

Within the Internet 3, Web pages are typically encoded in a language (e.g. HTML) that permits to transmission of different kinds of information, as text, graphics and sound. In the embodiment of the present invention that is currently described, the home page of server 1 is encoded in this manner. Thus, the browser 11 running on the client 8 receiving the home page of server 1 interprets the Web page and displays it to the donating user 9.

The home page of server 1 can contain various information e.g. services, terms of use and links to other web pages that are stored on the server 1 or on other servers. Either the home page or a Web page that can be requested by the client 8 by following one or more links displayed on the home page and/or subsequent Web pages comprises a field for data input.

In step 102, the donating user 9 types a keyword into the field for data input. The keyword is a string that identifies a receiving user. For example, the keyword can be the name or an alias of the receiving user 6. The donating user 9 causes the client 8 to transmit the keyword to the search engine 16 of server 1. The search engine 16 accesses the information stored on database 4 and causes the server 1 to send information that is assigned to the receiving user 6 from the database 4 to the client 8. This information includes, for example, one or more events from the event list 13.

In step 103, the client 8 receives the information identifying one or more events assigned to the receiving user 6. The client 8 causes this information to be displayed to the donating user 9 via the browser 11, e.g. by displaying a list of events, with each event being described by its name and/or by its date. It is conceivable to represent each event that is displayed via the browser 11 by a link to further information about this event.

The donating user 9 selects at least one event from the list displayed by the browser 11. If the event is represented by a link the donating user 9 activates the link and thus follows the link. This causes the client to send information identifying the selected event to the server 1.

In a step 104 the server receives the information identifying at least one event that is assigned to the receiving user 6. The server 1 causes the data base 4 to extract information identifying the gifts that are assigned to the at least one event and to the receiving user 6. Therefore a component of the server 1 issues a request coded to the data base 4 according to a predefined interface, e.g. coded in SQL (Structured Query Language). The request will be interpreted by the database 4 and thus causes the database 4 to return the requested information.

If the data base 4 is embodied as illustrated in FIG. 2, the server can select the appropriate gift list 7 that is assigned to the at least one event. If the database 4 is configured in accordance with FIG. 3, the server can generate a request to the database 4 to extract all gifts that are assigned to the selected event. According to the example of FIG. 3, if the selected event is the “Birthday” of “receiving user A”, the database 4 will return gift 1 and gift 2. If the selected event is the “Saint's day” of “receiving user A”, the database 4 will only return gift 2. The server 1 will then send this information to the client 8, usually after generating a web page and putting the information in an appropriate format. The server 1 can also cause the database 4 to extract, for each gift that is assigned to the event, information identifying one or more shops that offer one or more of these gifts for sale. It is conceivable, that the database 4 stores, for each gift, at least one link to one shop that offers the gift for sale. This enables the server to include the links to the appropriate shops into the Web page that is to be sent to the client 8.

It has to be emphasized, that the internal representation of the information within the database 4 does not necessarily influence the information that can be retrieved by the server 1 from the database 4. The information that is retrievable from the database 4 is mainly influenced from the abstract information itself and from the interface for requesting information from the database 4 e.g. the so-called data base management system (DBMS).

In a step 105 the client 8 receives the information identifying at least one gift from the server 1, e.g. by receiving the Web page that was generated by the server 1 in step 104. The client 8 and the browser 11 cause this information to be displayed to the donating user 9. The information identifying a gift can be realized by a link to a shop that offers the gift for sale. Alternatively, the information can comprise a description of the gift, e.g. the price, technical specifications, options like color, size, etc. and in addition a link to at least one shop that offers the gift for sale.

In step 106, the donating user 9 selects at least one gift that was received in step 105 by the client 8. A selection can be performed in various ways, for example by activating a button that is assigned to the gift and displayed on the web page or by following a link that is assigned to the gift and displayed on the web page. However, in the embodiment described in FIG. 4 it is assumed that the web page comprises, for each gift, a link to a shop 12 that offers the gift for sale.

In step 106, the donating user 9 selects a gift by following the link to the shop 12. This causes the client 8 to request information from the shop 12 concerning the gift, e.g. price, availability, cost for shipping, and the like. The link can therefore include an URL of a web page that is stored by the shop 12 and that is assigned to the gift.

The shop 12 receives the request and responds by sending the requested information to the client 8. Sending a Web page that is already stored in a database assigned to the shop 12 can do this. It is also conceivable, that the shop 12 generates a Web page dynamically depending on the request from the client 8. Therefore the shop 12 takes appropriate information from a product database that is assigned to the shop 12. The Web page sent from the shop 12 to the client 8 includes a button to issue a purchase order. The client 8 receives the Web page from the shop 12 and displays it to the donating user 9.

Alternatively, it is conceivable that the Web page that lists one or more gifts and is sent from the server 1 to the donating user 9 lists, for each gift, one or more shops 12 that sell the gift, accompanied by further information like price, availability, etc. For each gift and each shop that offer the gift for sale the Web page can also contain a button for issuing a purchase order.

In a step 107, the donating user 9 issues a purchase order by activating the appropriate button displayed on the Web page. The purchase order is sent to the online shop.

In another embodiment, the purchase order is sent from the client 8 to the server 1. The server then forwards the purchase order to one of the shops 12 or generates itself a purchase order for a shop 12 (e.g. wherein the shop 12 provides a B2B interface).

In a step 108 the shop 12 informs the server 1 that the gift is purchased. Therefore the shop 12 sends appropriate data to the server 1. The server 1 receives these data and causes the database to remove the gift from the gift lists 7 that are assigned to the receiving user 6. Thus, if the same or another donating user 9 now request information from the server 1 about one or more gifts that are assigned to the receiving user 6, the gift already purchased in step 107 will no longer be included into the Web page that is sent to the same or other donating user 9 in response to the request.

In a step 109 the shop 12 causes the gift to be sent to the receiving user 6. Therefore, it is conceivable that the shop 12 receives information from the server 1 or the client 8 assigned to the donating user 9 for identifying the date of the event that is selected in step 103.

In another embodiment of the present invention, the server 1 provides the possibility of automatically generating and/or sending an acknowledgement to the donating user 9 after the gift is donated to the receiving user 6. Therefore, the server 1 can store information related to the gift that is purchased by the donating user 9 in step 107 and removed from the gift list of the receiving user 6 in step 108. This information includes information identifying the donating user 9. The server 1 then generates an acknowledgment that is addressed to the donating user 9. The server 1 can then make the acknowledgement available to the receiving user 6. The receiving user 6 modifies the acknowledgement and causes the server 1 to send it to the donating user 9. It is conceivable, that the receiving user 6 sends the acknowledgement to the donating user 9. It is also conceivable; that the server 1 automatically generates the acknowledgement and sends it to the donating user 9 after the event the gift is assigned to has occurred. Moreover, the shop at which the gift is purchased can generate and/or send the acknowledgement to the donating user 9. The acknowledgement can be sent to the donating user 9 e.g. postal, by e-mail, by SMS, or as the case maybe.

For adding, removing and modifying information stored in the database 4, the server 1 provides a so-called portal. The portal can be realized as a dynamic Web page that allows a receiving user 6 to retrieve information from the database 4 that is assigned to the receiving user 6, to modify the information and to add new information. This information can be, for example, information identifying an event, information identifying a gift, information identifying a donating user 9 and information describing various combinations of such information. To ensure that only the receiving user 6 can modify the information assigned to him, each receiving user 6 has to be registered by the server 1 or at least by the data base 4. Various mechanisms for registering are known. Typically, each receiving user 6 obtains a unique user identification and a password. To modify, add or remove information, each receiving user 6 first has to log in, i.e. pass the user identification and the password to the server 1 or at least to the data base 4. Therefore, the server 1 provides a Web page that comprises a login screen or at least an input field for typing the user identification and an input field for typing the password.

Once the receiving user 6 is logged in, it is conceivable that the server 1 causes the client 8 assigned to the receiving user 6 to store a so-called cookie. A cookie primarily is a string that is transmitted from the client 8 to the server 1, whenever the client 8 requests a Web page from the server 1. When the receiving user 6 wants to log in another time, the server 1 automatically recognizes the receiving user 6 and prompts the receiving user 6 to type the password.

Once the receiving user 6 is logged in, according to one embodiment of the invention, the server 1 transmits a Web page to the client 8 that realizes a graphical user interface and allows the receiving user 6 to change and remove information that define one or more gifts or that are assigned to one or more gifts. In particular, the receiving user 6 can add, change or remove information identifying a gift, add, change or remove information identifying an event, add, and change or remove information identifying a donating user 9.

To add a gift to the database 4, it is conceivable that the server 1 maintains a product database or at least a list of products, wherein each product can be selected by the receiving user 6. If the receiving user 6 selects a gift from the product database, the server 1 causes a Web page to be sent to the client 8 of the receiving user 6 that allows the receiving user 6 to specify further information that will be assigned to the selected gift.

It is also conceivable that the receiving user 6 selects an item from one of the shops 12 that are assigned to the server 1 and causes the selected item to be added as a gift to the data base 4 e.g. by activating a button that is displayed on a Web page together with some information (e.g. price, picture, availability) according to the item. If the receiving user 6 activates the button, the shop 12 sends a message to the server 1 that identifies the item and the receiving user 6. It is further possible, that activating the button by the receiving user 6 causes the client 8 that is assigned to the receiving user 6 to send a message to the server 1 identifying the item and the receiving user 6. Therefore the button can be realized as a link to the server 1. The link can include information identifying the selected item. Following the link thus causes the selected item to become known to the server 1. The server 1 can then ask the receiving user 6 to identify himself e.g. by typing the name and/or the password assigned to the receiving user 6.

In another embodiment of the invention the receiving user 6 adds an item by sending an SMS or an e-mail to the server 1, wherein the SMS or the e-mail contains information for identifying the receiving user 6 and the item that has to be added as a gift to the data base 4.

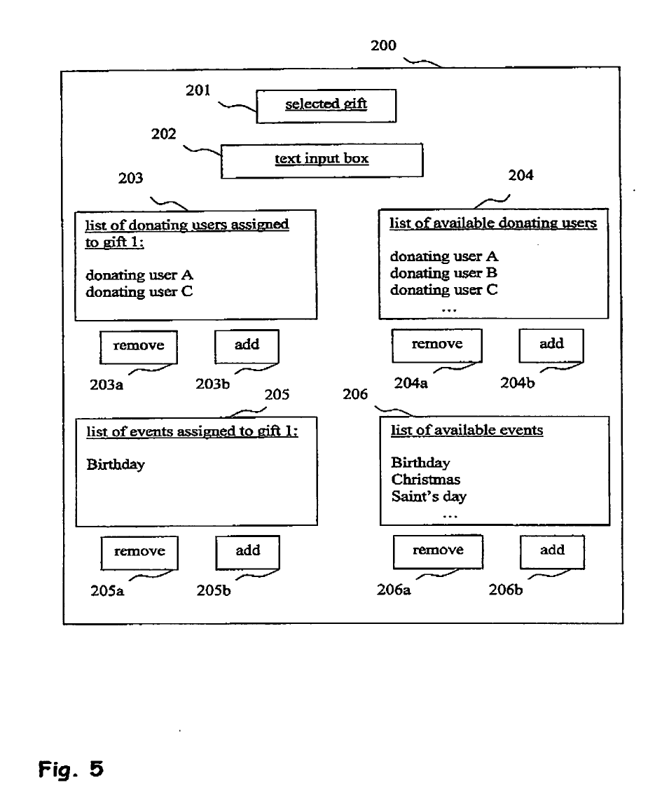

FIG. 5 shows a schematic block diagram of an embodiment of a Web page 200 that allows the receiving user 6 to specify further information. The Web page 200 comprises a field 201 that shows information identifying the selected gift. This information can be a textual representation of the gift and/or a graphic representation of the gift.

In a box 203, a list of donating users 6 that are assigned to the selected gift is displayed. Two buttons 203a, 203b are attached to the box 203 for removing or adding an entry in the list displayed in box 203. In a box 204 a list of available donating users 6 is displayed. Two buttons 204a, 204b are attached to the box 204 for removing or adding an entry in the list displayed in box 204. In a box 205, a list of events assigned to the selected gift is displayed. Two buttons 205a, 205b are attached to the box 205 for removing or adding an entry in the list displayed in box 205. In a box 206, a list of available events that are assigned to the receiving user 6 is displayed. Two buttons 206a, 206b are attached to the box 206 for removing or adding an entry in the list displayed in box 206.

The Web page 200 further comprises a text input field 202 that allows the receiving user 6 to input text e.g. by typing or by marking the text in one of the boxes 203, 204, 205, 206.

For adding a donating user 9 to the list of available donating users 9 as displayed in box 204, the receiving user 6 types an identifier (e.g. the name of the donating user 9) in the field 202 that identifies the new donating user 9. The receiving user 6 then activates the button 204b. This causes a refresh of the Web page 200 which will now show a modified list 204 where the new donating user 9 is added.

For assigning a further donating user 9 to the list of donating users 9 assigned to the selected gift as displayed in box 203, the receiving user 6 selects a donating user 9 in the list 204. This causes an identifier identifying the selected donating user 9 to be displayed in the field 202. The receiving user 6 then activates the button 203a. This causes a refresh of the Web page 200 which will now show a modified list 203 where the selected donating user 9 is added. Of course, various different and functional and graphical realizations of such a portal are possible as will be clear to one skilled in the art.

Various different ways for adding and modifying the data that are stored in the data base 4 and assigned to the receiving user 6 are possible. For example, the receiving user 6 can add a new gift to the database 4 by first searching one or more of the shops 12 for information according to items that the receiving user 6 would like to receive as a gift. Having found an appropriate gift, the receiving user 6 requests information describing the new gift. This causes the shop 12 to send a Web page to the client 8 of the receiving user 6, which displays the requested information. The Web page also comprises a button that allows the receiving user 6 to add the gift to the database 4. Activating this button by the receiving user 6 can cause the client to send information identifying the gift to the server 1 together with a request for adding this gift to one individual entry of the receiving user 6 in the database 4. In response, the server 1 sends the Web page 200 to the client such that the receiving user 6 can specify further data that have to be assigned to the gift as described above.

The flow chart shown in FIG. 4 and described above shows just one possible embodiment of the present invention. Various different embodiments of the present invention are conceivable. Some of them are described in the following.

It is conceivable, that the donating user 9 starts the process 100 of selecting and purchasing a gift for the receiving user 6 by directly issuing an individualized URL that will be sent to the server 1 and which causes the server 1 to identify the receiving user 6. For example, this URL can be generated by the server 1 itself and can be passed to the receiving user 6 e.g. by e-mail. The receiving user 6 in turn can forward (e.g. by e-mail) this URL to one or more donating users 9. Moreover, this URL can be generated such that it causes the server 1 to send a Web page to the client 8 that is assigned to the donating user 9, wherein the Web page already contains information identifying one or more events and/or information identifying one or more gifts that are assigned to the receiving user 6.

It is possible that the server 1 checks in step 102 and/or in step 103, whether the donating user 9 is allowed to retrieve information about the receiving user 6 at all or whether the donating user 9 is allowed to retrieve information about one or more events that are assigned to the receiving user 6. It is also possible, that, for each gift that is assigned to the receiving user 6, the server 1 checks whether the donating user 9 is allowed to retrieve information defining this gift. To realize this feature, the data base 4 can provide an entry for each receiving user 6, for each event that is assigned to the receiving user 6, and/or for each gift that is assigned to the receiving user 6 in order to store information identifying one or more donating users 9 that should be permitted to retrieve the appropriate information.

According to another embodiment of the invention, step 103 is omitted. Instead, server 1 extracts in step 104 all gifts assigned to the receiving user 6, wherein the receiving user 6 is identified in step 102. According to this embodiment, each gift displayed to the donating user 9 in step 105 is supplemented by information identifying which event the gift is assigned to. It is also possible, that one or more gifts are not supplemented by this information. This can be interpreted such that these gifts are assigned to all events.

It is conceivable, that the selection of a gift in step 106 causes the client 8 to request a Web page from the server 1 comprising information that show, which shops 12 offer this gift for sale. It is further conceivable, that for each of these shops 12 information is added according the price, the availability and/or the earliest delivery time. The donating user 9 can than select one of the shops 12 that seems to be appropriate to his needs.

According to another embodiment of the present invention, the selection of a gift in step 106 causes the client 8 to send information to the server 1 such that the server 1 can identify the selected gift and possibly the receiving user 6. The server 1 then causes a change in the database 4 for blocking this gift. This can be realized such that if another donating user 9 requests a gift list 7 of the receiving user 6 containing this gift, the gift will not be displayed to the other user. Alternatively, the server 1 can cause the gift to be marked in a way that the other donating user 9 detects that the gift is already selected by the first donating user 9. This prevents the other user from purchasing a gift that might also be purchased by the first donating user 9.

It is further conceivable, that the selection of a gift in step 106 also causes the client 8 to request, receive and store a cookie from the server 1. This cookie can include information about the selected gift and information identifying the receiving user 6. When the donating user 9 purchases the gift in step 107, the client can send the cookie to the server 1. This allows the server 1 to detect that the donating user 9 purchases the gift and that the server has to remove the gift from the gift list in step 108.

Instead of sending the gift directly to the receiving user 6 in step 109, it is conceivable that the shop 12 causes the gift to be sent to the donating user 9. This enables the donating user 9 to present the gift personally to the receiving user 6.

In another embodiment of the present invention, the server system 1 sends information to the client system 8 indicating that at least one event out of the event list 13 assigned to the receiving user 6 will occur within a predefined period of time. This can be realized e.g. by sending an e-mail to the donating user 9 or by sending an SMS (Short Message Service) to the client 8 (e.g. a mobile telephone) that is assigned to the donating user 9. Together with this kind of reminder a list of one or more gifts can be sent to the donating user 9, wherein each gift is taken from the database 4 and is assigned to the receiving user 6 and to the event. If the reminder is sent by e-mail, it is conceivable to sent it as a Web page realized such that the donating user 9 can cause the purchase of one or more of the gifts by just activating one button that is displayed on the Web page.

According to a further embodiment of the present invention, the database 4 comprises features of a so-called community. This means that at least each receiving user 6 has to be a member of the community. Each receiving user 6 can specify one or more other receiving users 6. This can be viewed as a directed at least cycled graph. Each donating user 9 that is assigned to view the gift lists of a receiving user 6 is also allowed to view the gift lists of the receiving users 6 that are specified by the receiving user 6. It is also conceivable, that each donating user 9 that is allowed to view the gift lists of a first receiving user 6 is allowed to view the gift lists of all receiving users 6 that specify the first receiving user 6.

In another embodiment of the server 1, a donating user 9 can search the database 4 to find out, whether a specified receiving user 6 provides a gift list. If the donating user 9 is not allowed to view the gift list, the donating user 9 can ask the receiving user 6 (e.g. via e-mail) whether he will allow the donating user 9 to view the gift list. The receiving user 6 can then admit the donating user 9 to view the gift lists e.g. by sending a so called activation key to the donating user 9. The donating user 9 in turn can transmit the activation key to the server 1. This will cause the server 1 to send information to the donating user 9 concerning the events and gifts that are assigned to the receiving user 6.

We claim:

1. A method for selecting and purchasing a gift, the method comprising the steps of:
a) sending information identifying a receiving user to a server system using a client system instructed by a donating user;
b) sending information to the client system using the server system, said information identifying at least one gift from a gift list, wherein the gift list is assigned to the receiving user and wherein the gift is offered for sale by an online-shop that is assigned to the server system;
c) receiving the information identifying the gift and displaying a description of the gift using the client system for viewing by the donating user;
d) selecting the gift in response to instructions by the donating user;
e) communicating a request to purchase the selected gift to the online-shop; and
f) removing, using the server system, the selected gift from the gift list if the gift is purchased by the donating user.

2. The method of claim 1, wherein the server system identifies the receiving user and determines whether the client system is authorized to retrieve information assigned to the receiving user.

3. The method of claim 1, wherein the client system causes at least one event to be displayed to the donating user, the event being assigned to the receiving user, and at least one gift from the gift list of the receiving user is assigned to the event, wherein the donating user selects the event and causes the client system to send information identifying the selected event to the server system, and the server system sends information to the client system identifying at least one gift assigned to a gift list, the gift list being assigned to the receiving user, and the gift is offered for sale by an on-line-shop that is assigned to the server system, wherein the gift is assigned to the selected event.

4. The method of claim 1, wherein, if the purchase of the selected gift is cancelled, the online-shop sends information to the server system indicating that the purchase of the selected gift is cancelled, and the server system adds the gift to the gift list.

5. The method of claim 1, wherein the receiving user modifies the gift list by adding or removing information identifying a gift.

6. The method of claim 2, wherein the receiving user modifies the event list by adding or removing an event.

7. The method of claim 1, wherein the gift purchased by the donating user is automatically sent to the receiving user at a date that depends on the event assigned to the gift.

8. The method of claim 1, wherein, at least for the gift selected by the donating user, the server system automatically selects the online-shop out of a list of online-shops according to at least one selection criterion.

9. The method of claim 1, wherein the client system sends information to the server system that identifies the gift selected by the donating user, and the server system receives that information, wherein if another client system requests information identifying at least one gift from that gift list, the server system will not send the information identifying the selected gift to the other client system, at least until a predefined event occurs.

10. The method of claim 1, wherein the server system sends information to the client system indicating that at least one event out of the event list assigned to the receiving user will occur within a predefined period of time.

11. A server system for facilitating selection and purchase of a gift, the server system comprising:
an event database that holds an event list containing information identifying at least one event that is assigned to a receiving user;
a gift database that holds at least one gift list containing information identifying at least one gift assigned to the receiving user;
at least one online-shop facility for offering the gift for sale;
means for receiving an event request from at least one client system, the client system requesting information identifying at least one event from the event list, wherein the client system is assigned to a donating user;
means for receiving a gift request from the client system, wherein the client system requests information identifying at least one gift from the gift list;
means for detecting whether or not the gift is purchased by a donating user; and
means for removing the gift from the gift list of the receiving user if the gift is purchased from the donating user at the online-shop.

12. The server system of claim 11, further comprising means for determining whether the client system is allowed to request information that is assigned to the receiving user.

13. The server system of claim 11, further comprising means for receiving information from the online-shop indicating that the donating user has cancelled the purchase of the selected gift, and means for adding the gift to the gift list if information is received indicating that the donating user has cancelled the purchase of the selected gift.

14. The server system of claim 11, further comprising a database means for assigning at least one donating user to at least one receiving user.

15. The server system of claim 14, further comprising means for sending information to the client system indicating that at least one event from the event list will occur within a predefined period of time.
